(19) United States
(12) Patent Application Publication
(10) Pub. No.: US 2005/0220968 A1
(43) Pub. Date: Oct. 6, 2005

(54) Process for the production of micronutrient rich zero-trans shortening interesterification

(75) Inventors: Arumughan Chami, Kerala (IN); Nichlavose Mayamol Ponmalakunnel, Karela (IN); Thomas Samuel, Karela (IN); Pillai Balachandran Chandrasekharan, Kerala (IN); Sundaresan Andikkannu, Karela (IN)

Correspondence Address: Ladas & Parry, 26 West 61 Street, New York, NY, 10023, US

(73) Assignee: COUNCIL OF SCIENTIFIC AND INDUSTRIAL RESEARCH

(21) Appl. No.: 10/815,113

(22) Filed: Mar. 31, 2004

(51) Int. Cl. A23D 7/00

(52) U.S. Cl. 426/603

(57) ABSTRACT

A process for the production of polyunsaturated fatty acid and micronutrient rich zero-trans shortening by chemical interesterification to produce nutritionally and fictionally superior shortening without hydrogenation. The process involves blending of palm oat and palm stearin with rice bran oil, interesterification in the presence of sodium methoxide catalyst, inactivation of the catalyst, washing with hot water, deoderization of the resultant product, and finally passing the interesterified product through margarine crystallizer under controlled conditions followed by packing and tempering.

This invention relates to a novel process for the production of micronutrient rich zero-trans shortening at pilot scale using palm oil and its fractions such as palm stearin with rice bran oil by chemical interesterification.

Shortenings are plastic fits consisting of a mixture of solid fat crystals and liquid oils which give greater functionality for certain specific applications. Satisfactory performance of shortening depends mainly on consistency and crystal structure. The consistency depends on the solid to liquid ratio (solid fit content) present at different temperatures. Shortening is used in frying, cooking, baking, and as an ingredient in fillings, icings, and confectionary items.

Traditional fats used in the baking industry include lard, tallow and butter. However, there is a trend towards utilization of vegetable oil based shortenings due to nutritional and economic considerations. Recently animal fits have steadily been replaced by partially hydrogenated vegetable oil or vegetable oil based bard fiat for shortening.

Shortenings may be classified on the basis of their chemical or physical characteristics, raw materials from which they are made or their intended application. Solid shortenings are classified according to their plasticity range. A shortening with a narrow plasticity range is hard at low temperatures and soft and particularly fluid at high temperatures. Shortenings in this category have high stability and are used for deep frying and in confectionary products. On the other hand, a shortening with a wide plasticity range has a flat solid fat content (SFC) curve. All-purpose shortenings are in this category and contain 15-30% solid fat and retain many of these solids over their intended temperature usage.

Most shortenings are identified and formulated according to their usage. Raw materials selection for shortenings has been influenced by availability and economics. These factors were the main reasons for the development and introduction of vegetable oils-based shortenings. Among vegetable oils, palm oil or its fraction appears to be alternative to animal fat for production of shortenings because of their solid fat content and is excellent plasticizing agent which stabilizes shortening's crystals in β′ form; the most desirable attributes for shortening.

The use of palm oil and its fractions can be maximized through modification processes to enhance their desirable properties. Besides fractionation; blending, hydrogenation and interesterification are common ways of modifying the characteristics of fats and oils. Hydrogenation alters the characteristics of fats and oils basically in three ways: (1) increases the slip melting point and SFC, (2) improves stability, (3) favors β′ crystals. In the hardening process, hydrogen gas is reacted with oil at a high temperature and pressure in the presence of catalyst like Ni, Pt or Pd with agitation. Hydrogenation not only reduces the unsturation of the fat but also increases melting point through formation of trans fatty acids. Trans fatty acids are now considered a risk factor for cardio-vascular disease. Besides, nickel catalyst used for hydrogenation is toxic and removal of Ni to the prescribed level is becoming increasingly expensive. This has raised the need to replace hydrogenated fats with natural fats. Regulatory mechanism to limit trans fatty acids are being contemplated in USA, European union, Japan and other countries through mandatory declaration of trans fatty acids in food products. Consequently industries involved in food processing and fast food companies are looking for alternative to hydrogenation for making shortening and hard fits. Blending of fats and interesterification are alternatives to hydrogenation process to impart desired functionality without trans-fatty acids. Interesterification is a process that changes the natural distribution of fatty acids in triacylglycerols through randomization but without changing the fatty acid composition. This rearrangement alters the physical and functional properties of the oils or fats and is accomplished by a catalyst mediated reaction at relatively low temperature and pressure. However, changes in the physical characteristics and functional properties could be either desirable or undesirable that would largely depend on the formulation of blend. Therefore selection of it blend is critical for this process. Palm oil and its fraction are ideal solid fat ingredient of the blend for functional attributes of shortening. There are two types of interesterification namely, chemical interesterification and enzymatic interesterification.

A fit product with low trans-fatty acid content and a solid fat content profile similar to that of hydrogenated palm oil was described in an European patent [EP 1249172 A 1 (2002)] [EP 01-109108 (20010412) (Nestle, 1800 Vevey, Switzerland]. A [U.S. Pat. No. 6,238,926 B1 (2001)] on partial interesterification was reported. Literature reports are available on chemical interesterification using palm oil and soybean oil, and lard with canola oil and their melting and crystallization behavior. [Alejandro G. Marangoni and Derick Rousse, JAOCS, Vol. 75, no. 10, 1998]. Physical and chemical properties of fat blends by chemical interesterification using palm stearin or fully hydrogenated soybean oil with a native vegetable oil (soybean oil) in a laboratory scale was reported [V. Petrauskaite, W. De Greyt, M. Kellens, and A. Huyghebaert, JAOCS, Vol. 75, no. 4, 1998]. Physical properties of interesterified fit blends by chemical interesterification using fully hydrogenated soybean oil with different vegetable oils such as sunflower oil, cottonseed, corn, palm oil, peanut, safflower and coconut oil was also reported [M. A. M. Zeitoun, W. E. Neff, G. R. List and T. L. Mounts, JAOCS, Vol. 70, no. 5, 1993]. Scrutiny of these reports would reveal that all these products contain varying amounts of tans fatty acids, since hydrogenated fit was one of the ingredients. Besides, attention was not paid to select fat or oil rich in micronutrient in the earlier reports, so as to make the end product not only devoid of trans fatty acids but rich in health promoting micronutrients. Recently a process for zero-trans shortening was developed at pilot scale in this laboratory through simple blending of palm stearin and rice bran oil followed by crystallization in votator under specified conditions. A patent application is filed in India. The present invention deals with a process developed through interesterification with various combinations of palm stearin, whole palm oil and rice bran oil.

The main objective of the present invention is to provide a commercially feasible process for the production of nutritionally superior interesterified zero-trans shortening.

Another objective of the present invention is to provide a method for the production of interesterified all-purpose zero-trans shortening.

Another objective of the preset invention is to provide a method for the production of polyunsaturated rich interesterified zero-trans shortening.

Another objective of the present invention is to provide method for the production of granular, crystalline interesterified zero-trans shortening with maximum β′ polymorphic form, which imparts good textural properties.

Another objective of the present invention is to provide a method for the production of interesterified zero-trans shortening rich in micronutrients such as tocopherols, tocotrienols, carotenes, oryzanol and phytosterols.

Another objective of the present invention is to provide method for the production of interesterified zero-trans shortening conforming to specificational requirements such as melting point, FFA, moisture, Iodine value etc.

Accordingly the present invention provides a process for the production of interesterified zero-trans shortening which involves blending of palm oil and palm stearin, with an unsaturated liquid oil viz refined rice bran oil, interesterification in presence of sodium methoxide catalyst, inactivation of the catalyst, washing with hot water, deodorization of the resultant product in a deodorizer, and finally passing the interesterified product through margarine crystallizer under controlled conditions followed by packing and tempering.

In an embodiment of the present invention, melted palm stearin or refined palm oil is blended with refined rice bran oil in a particular proportion.

In another embodiment of the present invention, the heated homogeneous blend is subjected to interesterification reaction.

In yet another embodiment of the present invention, the interesterified product is processed through the margarine crystallizer under controlled conditions.

In another embodiment of the present invention, the product from the crystallizer unit is tubbed and tempered.

The following procedure has been developed for the production of palm oil based interesterified zero-trans shortening.

Palm stearin or neutralized palm oil is melted to 60-80° C. and blended with rice bran oil in a ratio of 90:10 to 10:90 and the whole mixture is heated to 60-110° C. under vacuum and 0.2-0.9% sodium methoxide is added as catalyst and the mixture is vigorously stirred at 60-110° C. for 5-60 mints, and the reaction mixture is cooled to 50-70° C., and 0.2-1.2% citric acid is added to neutralize the catalyst, and finally the mixture is washed with hot water at 60-90° C. until neutral. The interesterified fat is deodorized at 140-180° C. under 0-5 mmHg vacuum for 1-4 hrs. The resultant interesterified fit at 50-80° C. is cooled by passing through the margarine crystallizer (scraped surface heat exchanger) to a temperature of 20-30° C. under controlled conditions of refrigerant temperature, feed rate, back pressure, mutator speed, pinworker speed and filling temperature. The crystalline semi-solid zero-trans shortening is tubbed and tempered for 3-10 days at 25-35° C.

Fatty acids in the natural fats and oils are esterified preferentially to the Sn 1,2, 3 hydroxyl groups of glycerol molecules due to specificity of the enzymes involved for these hydroxyl groups. Fatty acids therefore are non-randomly distributed in the triacylglycerol molecules in fats and oils which in turn govern their physicochemical and nutritional properties of the individual fats and oils. Interesterification is a chemical/enzymatic invitro process by which the non-random distribution of fatty acids is changed to random distribution in the glycerolmolecules. An interesterification reaction is illustrated as follows.

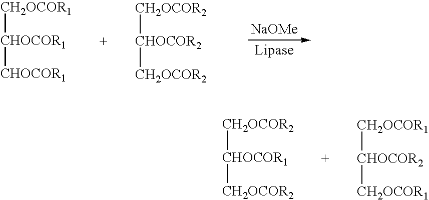

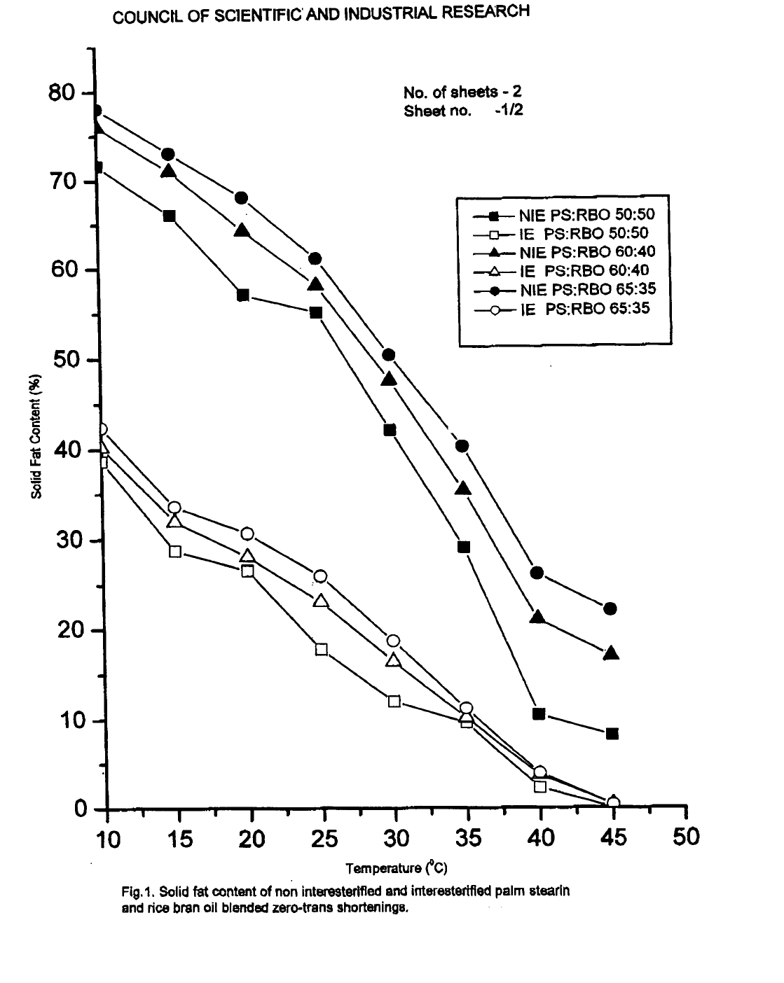

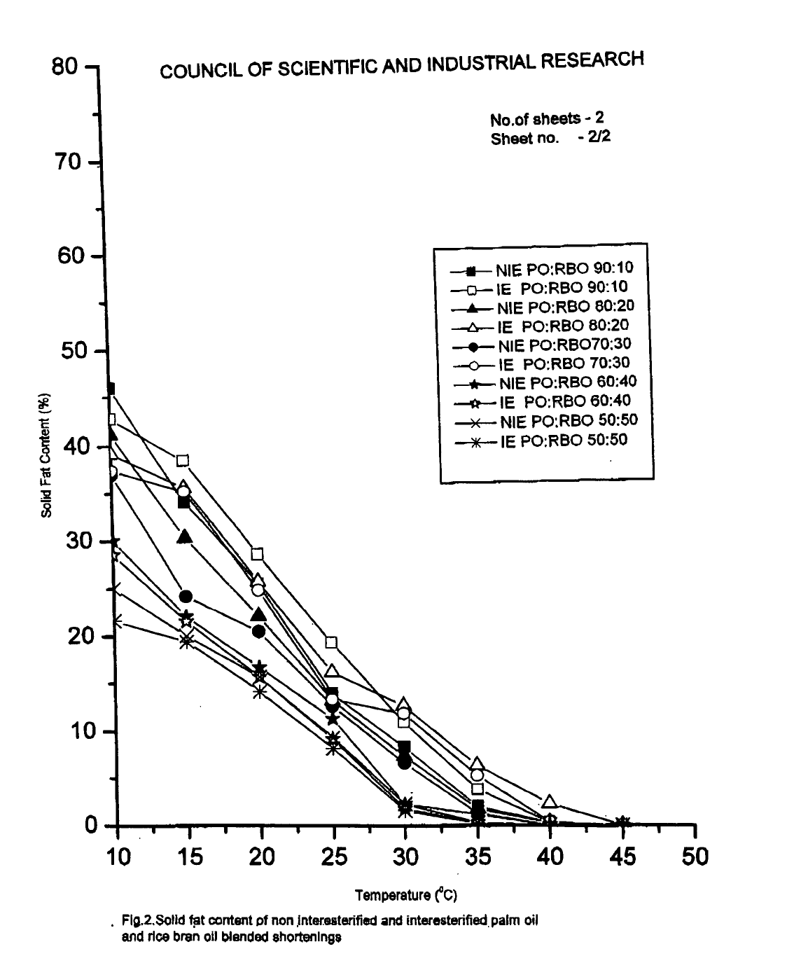

Interesterification induces therefore changes in triacylglycerol composition of the fat. In the present process interesterification resulted in a decrease of high melting triglycerides (PPP, POP) and triunsaturated glycerides (OLL, OOO) and formation of diunsaturated monosaturated glycerides. The altered TAG composition of the interesterified shortening was also reflected in the slip melting point and solid fit content (SFC). This decrease in the slip melting point can be explained by the decrease of the higher-melting trisaturated proportion. Triacylglycerol (TAG) composition of the non interesterified palm stearin and rice bran oil blend and the corresponding interesteried product are given in table 5. SFC (% of solid content at any temperature) at various temperatures determines the plasticity of the shortenings. Plasticity of shortenings enables to spread readily and combine thoroughly with other solids or liquids without cracking, or liquid oil separating from the crystalline fit. SFC curve of the interesterified shortening of the present process was changed significantly. Interesterified shortening tended to have lower SFC values than non interesterified fat blend when palm stearin was blended with RBO (FIG. 1) whereas interesterified palm oil and rice bran oil based shortenings in the ratio of 90 to 70% palm oil and 10 to 30% rice bran oil bad higher SFC than the corresponding non interestrified shortenings. When the palm oil composition decreased from 70 to 50% and RBO increased from 30 to 50%, after interesterification, the resultant product tended to have lower SFC than their corresponding interesterified shortenngs (FIG. 2). Typical all purpose plastic shortenings contain 15-30% solid fit and retain the solids over their intended temperature of usage under ambient conditions (16-32° C.). In the present process, the formulations containing 50-60% palm stearin and 40-50% rice bran oil and 70-80% palm oil and 20-30% rice bran oil had SFC and plasticity suitable for plastic shortenigs and therefore fall under the category of all-purpose zero-trans shortenings. An important criterion in the manufacture of shortening is to obtain a granular crystalline structure and a minimum free oil phase at room temperature. The crystalline form of the fat/oil blend is also very important. The primary crystal forms are α, β′ and β. The β′ form of crystals is desired for favorable molecular packing of the fatty acid chains of a solid fat used for production of shortening. In the present process after interesterification there was a significant increase in the amount of desirable β′ polymorphic form in the shortenings (Table 1 and 3), which is primarily attributable to the selection of fat blends.

The primary purpose of tempering is to condition the solidified shortening so that it will withstand wide temperature variations in subsequent storage and to have a uniform consistency. The physico-chemical characteristics of interesterified palm stearin, rice bran oil and palm oil, rice bran oil blended shortenings are given in Table 1 and 3.

The following examples are given by way of illustration and therefore should not be constructed to limit the scope of the present invention.

### EXAMPLE 1

18 kgs of palm stearin, rice bran oil blend in the ratio of 50:50 was heated to 80° C. under vacuum and 0.5% sodium methoxide catalyst was added and the mixture was vigorously stirred at this temperature for 30 mints. After 30 mints reaction, the mixture was cooled to 70° C. Calculated amount of citric acid to inactivate catalyst (117 gms) was dissolved in 2.5 lit water and admitted into the reactor with slow stirring for 30 mints, and the aqueous layer was separated. The reaction mixture was washed with hot water at 85° C. till neutral. The interesterified fit was deodorized (1-5 mabr, 160° C., 2.5 h). The result interesterified fit was cooled to 70° C. and processed through a margarine crystallizer. Refrigerant temperature of the margarine crystallizer was adjusted to 20° C., so that the equilibrium temperature of the product attained at the inlet barrel of the mutator was 50° C. 8 kgs of the homogeneous melted interesterified fat blend at 70° C. was fed into the margarine crystallizer with a feed rate of 10 kg/hr and enters the scraped surface heat exchanger (mutator). The pressure inside the mutator was adjusted to 8 bar where the material crystallizes to the required level at 28.7° C. The speed of the mutator was adjusted to 200 rpm. The output of the heat exchanger at a temperature of 28.7° C. was allowed to enter into the pinworker to get a uniform distribution of the crystals formed. The pinworker movement was fixed to 50 rpm. The material coming out of the pinworker at a temperature of 29.2° C. was passed through a resting tube and 7.5 kgs of the product was collected and tubbed at this temperature and kept for tempering at 31° C. for 3 days.

### EXAMPLE 2

20 kgs of palm stearin, rice bran oil blend in the ratio of 60;40 was heated to 85° C. under vacuum (80 mmHg) and 0.5% sodium methoxide catalyst was added and the mixture was vigorously stirred at this temperature for 60 mints. After 60 mits reaction, the mixture was cooled to 70° C. Calculated amount of citric acid to inactivate the catalyst (130 gms) was dissolved in 2.5 lit water and admitted into the reactor with slow stirring or 30 mints, and the aqueous layer was separated. The reaction mixes was washed with hot water at 80° C. till neutral. The interesterified fat was deodorized (1-5 mbar, 160° C., 2.5 h). The resultant interesterified fat was cooled to 70° C. and processed through margarine crystallizer. Refrigerant temperature of the margarine crystallizer was adjusted to 15° C. 10 kgs of the homogeneous melted blend at 70° C. was fed into the margarine crystallizer with a feed rate of 10 kg/hr and enters the scraped surface heat exchanger. The pressure inside the mutator was adjusted to 8 bar where the material crystallizes to the required level at 26.3° C. The speed of the mutator was adjusted to 200 rpm. The output of the heat exchanger at a temperature of 26.3° C. was allowed to enter into the pinworker to get a uniform distribution of the crystals formed. The pinworker movement was fixed to 50 rpm. The material coming out of the pinworker at a temperature of 26.7° C. was passed through a resting tube and 9.5 kgs of the product was collected and tubbed at this temperature and kept for tempering at 31° C. for 5 days.

### EXAMPLE 3

18 kgs of refined palm oil, rice bran oil blend in the ratio of 70:30 was heated to 85° C. under vacuum (80 mmHg) and 0.5% sodium methoxide was added and the mixture was vigorously stirred at this temperature for 30 mints. After 30 mints reaction, the mixture was cooled to 70° C. Calculated amount of citric acid to inactivate the catalyst (117 gms) was dissolved in 2.5 lit water and admitted into the reactor with slow stirring or 30 mints, and the aqueous layer was separated. The reaction mixture was washed with hot water at 80° C. till neutral. The interesterified fat was deodorized (1-5 mbr, 160° C., 2.5 h). The resultant interesterified fat was cooled to 70° C. and processed through margarine crystallizer. Refrigerant temperature of the margarine crystallizer was adjusted to 10° C. 9 kgs of the homogeneous melted blend at 70° C. was fed into the margarine crystallizer with a feed rate of 10 kg/hr and enters the scrapped surface heat exchanger (mutator). The pressure inside the mutator was adjusted to 8 bar where the material crystallizes to the required level at 26.2° C. The speed of the mutator was adjusted to 200 rpm. The output of the heat exchanger at a temperature of 26.2° C. was allowed to enter into the pinworker to get a uniform distribution of the crystals formed. The pinworker movement was fixed to 50 rpm. The material coming out of the pinworker at a temperature of 26.5° C. was passed through a resting tube and 8.7 kgs of product was collected and tubbed at this temperature and kept for tempering at 31° C. for 7 days.

The main advantages of the present invention;
1) The novel process is cost effective and commercially viable for producing poly-unsaturated and micronutrients rich zero-trans all-purpose shortening.
2) Blending of palm stearin or palm oil with rice bran oil is highly beneficial in this process since rice bran oil contributes polyunsaturated content and micronutrients such as tocols, sterols and oryzanol in the final product, which have known health benefits.
3) Interesterification of palm stearin and rice bran oil blend resulted in a decrease of high melting triglycerides (PPP, POP) and triunsaturated glycerides (OLL, OOO) and formation of diunsaturated monosaturated glycerides resulted in the beneficial effects of decrease in slip melting point and solid fat content which increases the plasticity of the product.
4) Interesterification increased the desirable β′ polymorphic form, which is highly desirable for favorable textural properties.
5) Zero-tans shortenings with desirable functional properties can be produced by interesterification without hydrogenation. Ni catalyst used for hydrogenation is toxic and removal of Ni to the prescribed level is very difficult and expend.
6) With significantly reduced reaction time, low temperature and under vacuum the product has maximum retention of micronutrients and good oxidative stability.
7) Low temperature and shorter reaction time reduces the energy cost.

8) By cooling through the margarine crystallizer under controlled conditions of refrigerant temperature, feed rate, back pressure, mutator speed and pinwoker speed the product attained the required granular crystalline structure.

TABLE 1
Physico chemical characteristicts of non interesterified and interesterified
palm stearin and rice bran oil blended shortenings.

| | | | Slip | | | | | | |
|---|---|---|---|---|---|---|---|---|---|
| | | | Melting | | | | | | |
| | FFA | | Point | Tocols | Sterols | Oryzaol | Polymorphs(%) | | |
| Sample | (%) | IV | (° C.) | (ppm) | (%) | (%) | α | β′ | β |
| NIE PS:RBO(50:50) | 0.25 | 70.7 | 37 | 984 | 0.89 | 0.75 | 27.3 | 61 | 11.7 |
| IE PS:RBO(50:50) | 0.25 | 70.7 | 31 | 964 | 0.86 | 0.75 | — | 72 | 28 |
| NIE PS:RBO(60:40) | 0.25 | 65 | 38.5 | 939 | 0.73 | 0.53 | 25.9 | 59 | 15.1 |
| IE PS:RBO(60:40) | 0.25 | 65 | 33 | 920 | 0.69 | 0.53 | — | 72 | 28 |
| NIEPS:RBO(65:35) | 0.25 | 62 | 39 | 916 | 0.64 | 0.48 | 23 | 56 | 21 |
| IE PS:RBO(65:35) | 0.25 | 62 | 36 | 898 | 0.60 | 0.48 | — | 72 | 28 |

TABLE 2
Fatty acid composition of non interesterified and interesterified palm
stearin and rice bran oil blended shortenings.

| | Fatty acids (wt %) | | | | | | |
|---|---|---|---|---|---|---|---|
| Sample | C_{12:0} | C_{14:0} | C_{16:0} | C_{18:0} | C_{18:1} | C_{18:2} | Others |
| NIE | 1.1 | 1.1 | 41.1 | 2.8 | 34.4 | 18.7 | 0.8 |
| PS:RBO | | | | | | | |
| (50:50) | | | | | | | |
| IE PS:RBO | 1.1 | 1.1 | 41.2 | 2.7 | 34.4 | 18.6 | 0.9 |
| (50:50) | | | | | | | |
| NIE | 1.0 | 1.2 | 44.2 | 3.0 | 33.5 | 16.4 | 0.7 |
| PS:RBO | | | | | | | |
| (60:40) | | | | | | | |
| IE PS:RBO | 1.0 | 1.2 | 44.3 | 3.1 | 33.5 | 16.4 | 0.5 |
| (60:40) | | | | | | | |
| NIE | 1.1 | 1.2 | 45.7 | 3.2 | 33.1 | 15.2 | 0.5 |
| PS:RBO | | | | | | | |
| (65:35) | | | | | | | |
| IE PS:RBO | 1.1 | 1.2 | 45.8 | 3.1 | 33.1 | 15.2 | 0.5 |
| (65:35) | | | | | | | |

TABLE 3
Physico chemical characteristics of non interesterified and interesterified
palm oil rice bran oil blended shortenings.

| | | | Slip | | | | | | |
|---|---|---|---|---|---|---|---|---|---|
| | | | melting | | | | | | |
| | FFA | | point | Tocols | Sterols | Oryzanol | Polymorphs (%) | | |
| Sample | (%) | IV | (° C.) | (ppm) | (%) | (%) | α | β′ | β |
| NIE PO:RBO(50:50) | 0.25 | 78.4 | 24.5 | 1244 | 0.91 | 0.75 | — | 60.2 | 39.8 |
| IE PO:RBO (50:50) | 0.25 | 78.4 | 24 | 1217 | 0.88 | 0.75 | — | 73 | 27 |
| NIE PO:RBO(60:40) | 0.25 | 71 | 26.7 | 1254 | 0.73 | 0.53 | — | 60 | 40 |
| IE PO:RBO (60:40) | 0.25 | 71 | 26 | 1220 | 0.71 | 0.53 | — | 73 | 27 |
| NIE PO:RBO(70:30) | 0.25 | 65.8 | 28 | 1261 | 0.57 | 0.45 | — | 59.8 | 40.2 |
| IE PO:RBO (70:30) | 0.25 | 65.8 | 28.8 | 1224 | 0.56 | 0.45 | — | 72.3 | 27.7 |
| NIE PO:RBO(80:20) | 0.25 | 59.5 | 28.5 | 1267 | 0.40 | 0.3 | — | 46 | 54 |
| IE PO:RBO(80:20) | 0.25 | 59.5 | 31 | 1225 | 0.39 | 0.3 | — | 64 | 36 |
| NIE PO:RBO(90:10) | 0.25 | 54.5 | 29 | 1272 | 0.23 | 0.15 | — | 37 | 63 |
| IE PO:RBO(90:10) | 0.25 | 54.5 | 32.5 | 1230 | 0.22 | 0.15 | — | 62 | 38 |

TABLE 4
Fatty Acid Composition of non interesterified and interesterified
palm oil and rice bran oil blended shortenings

| | Fatty acids (wt %) | | | | | | |
|---|---|---|---|---|---|---|---|
| | | | | | | | Oth- |
| Sample | C_{12:0} | C_{14:0} | C_{16:0} | C_{18:0} | C_{18:1} | C_{18:2} | ers |
| NIE PO:RBO(50:50) | 0.2 | 1.0 | 31.4 | 2.2 | 41.7 | 22.4 | 1.1 |
| IE PO:RBO(50:50) | 0.22 | 1.1 | 31.4 | 2.18 | 41.7 | 22.3 | 1.1 |
| NIE PO:RBO(60:40) | 0.3 | 1.06 | 34 | 2.56 | 41.08 | 19.96 | 0.96 |
| IE PO:RBO(60:40) | 0.32 | 1.04 | 34.16 | 2.5 | 41.1 | 19.92 | 0.96 |
| NIE PO:RBO(70:30) | 0.35 | 1.12 | 36.68 | 2.75 | 40.76 | 17.5 | 0.82 |
| IE PO:RBO(70:30) | 0.35 | 1.11 | 36.67 | 2.75 | 40.77 | 17.53 | 0.82 |
| NIE PO:RBO(80:20) | 0.4 | 1.18 | 39.32 | 2.88 | 40.46 | 15.08 | 0.68 |
| IE PO:RBO(80:20) | 0.4 | 1.16 | 39.33 | 2.85 | 40.45 | 15.12 | 0.69 |
| NIE PO:RBO(90:10) | 0.45 | 1.24 | 41.96 | 3.04 | 40.13 | 12.64 | 0.54 |
| IE PO:RBO (90:10) | 0.43 | 1.21 | 41.92 | 3.03 | 40.12 | 12.69 | 0.6 |

TABLE 5
Triglyceride composition of non interesterified and interesterified palm
stearin and rice bran oil blended shortenings.

| Sample | OLL | PLL | OLO | PLO | PLP | OOO | POO | POP | PPP | SOO | POS | PPS |
|---|---|---|---|---|---|---|---|---|---|---|---|---|
| NIE | 6.3 | 6.9 | 7.2 | 16.3 | 7.6 | 7.9 | 16.2 | 17.6 | 7.8 | 1.1 | 2.9 | 1.7 |
| PS:RBO | | | | | | | | | | | | |
| (50:50) | | | | | | | | | | | | |
| IE | 1.8 | 12.9 | 7.6 | 25.3 | 14.4 | 6.4 | 15.2 | 9.2 | 3.1 | 0.98 | 1.6 | 1.2 |
| PS:RBO | | | | | | | | | | | | |
| (50:50) | | | | | | | | | | | | |
| NIE | 4.7 | 5.5 | 5.7 | 14.9 | 8.9 | 6.6 | 16.3 | 19.6 | 9.8 | 2.2 | 4.04 | 2.6 |
| PS:RBO | | | | | | | | | | | | |
| (60:40) | | | | | | | | | | | | |
| IE | 4.3 | 8.5 | 5.8 | 16.7 | 16.7 | 6.06 | 16 | 13.9 | 7.8 | 2.1 | 3.2 | 2.4 |
| PS:RBO | | | | | | | | | | | | |
| (60:40) | | | | | | | | | | | | |
| NIE | 4.2 | 4.86 | 5.8 | 14.2 | 9.2 | 6.4 | 16.3 | 21.1 | 10.2 | 2.8 | 4.6 | 2.6 |
| PS:RBO | | | | | | | | | | | | |
| (65:35) | | | | | | | | | | | | |
| IE | 3.8 | 7.8 | 5.8 | 16.2 | 11.8 | 6.1 | 16.02 | 15.9 | 7.3 | 2.6 | 3.2 | 2.6 |
| PS:RBO | | | | | | | | | | | | |
| (65:35) | | | | | | | | | | | | |

1. A novel process for the commercial production of polyunsaturated fatty acid and micronutrients rich zero-trans shortening by chemical interesterification to produce nutritionally and fictionally superior shortening without hydrogenation. The process involves blending of palm oat and palm stearin with rice bran oil, interesterification in presence of sodium methoxide catalyst, inactivation of the catalyst, washing with hot water, deoderization of the resultant product, and finally passing the interesterified product through margarine crystallizer under controlled conditions followed by packing and tempering.

2. A process as claimed in claim 1, wherein the required homogeneity is attained by heating the palm stearin or palm oil to 60.80° C., then adding rice bran oil in the proper proportion to the melted palm stearin or palm oil, and charging the blend to the reactor vessel and heating to a temperature of 60-110° C. under vacuum (60-80 mmHg) with stirring.

3. A process as claimed in claim 1, wherein 0.2-0.9% sodium methoxide catalyst is added with vigorous stirring for 5-60 mints under the above conditions of temperature and vacuum.

4. A process as claimed in claim 1, wherein sodium methoxide catalyst is inactivated by adding calculated amount of citric acid (0.2-1.2%) and aqueous layer is separated and again washed with hot water at 60-90° C. till neutral.

5. A process as claimed in claim 1, wherein the resultant interesterified product is deodorized at a temperature of 140-180° C. and under a vacuum of 1-5 mbar for 1-4 h.

6. A process as claimed in claim 1, wherein the resultant deodorized interesterified product at 50-80° C. is fed into the margarine crystallizer with a feed rate of 8-15 kg/hr.

7. A process as claimed in claim 1, wherein the refrigerant temperature of the margarine crystallizer is adjusted to 5-25° C.

8. A process as claimed in claim 1, wherein the interesterified fat fed into the margarine crystallizer is cooled to a temperature of 20-35° C.

9. A process as claimed in claim 1, wherein the backpressure in the scraped surface heat exchanger (muator) is adjusted to 5-10 bar.

10. A process as claimed in claim 1, wherein the interesterified fat is crystallized in the mutator at a mutator speed of 150-250 rpm.

11. A process as claimed in claim 1, wherein the product coming out of the mutator is subjected to beating in the pinworker at a speed of 50-150 rpm.

12. A process as claimed in claim 1, wherein the product collected from the margarine crystallizer under specified temperature of 20-35° C. and tubbed.

13. A process as claimed in claim 1, wherein the filled product is tempered at 25-35° C. for 3-10 days to get a plastic shortening with a requisite granular structure, which fall within the limits of specificational requirements.

14. A process as claimed in claim 1, wherein tocols enriched (900-1000 ppm) zero-traps shortening is obtained.

15. A process as claimed in claim 1, wherein phytosterols enriched (0.5.-1%) zero-trans shortening is obtained.

16. A process as claimed in claim 1, wherein oryzanol enriched (0.5-0.8%) zero-trans shortening is obtained.

17. A process as claimed in claim 1, wherein the interesterified zero-trans shortening fall under the category of all-purpose shortenings with good plasticity and maximum β′ polymorphic form (72%).

18. A process as claimed in claim 1, wherein the interesterified zero-trans all-purpose shortening has good oxidative stability.

19. A process as claimed in claim 1, wherein the polyunsaturated fatty acid and micronutrients rich zero-traps all-purpose shortening meets the specificational requirements such as slip melting point, FFA, moisture, unsaponifiable matter and iodine value prescribed for shortening.

20. A novel process for the production of zero-traps polyunsaturated fatty acid and micronutrients rich all-purpose shortenings with characteristics as in Table 1, 2, 3 and 4 by interesterification substantially as herein described with reference to the example cited.
